(19) United States
(12) Patent Application Publication
(10) Pub. No.: US 2023/0389478 A1
(43) Pub. Date: Dec. 7, 2023

(54) SYSTEMS AND METHODS FOR TRUCK TRANSITIONS DURING HARVESTING

(71) Applicant: SNAKE RIVER MANUFACTURING, Heyburn, ID (US)

(72) Inventor: Ryan OLSON, Heyburn, ID (US)

(73) Assignee: SNAKE RIVER MANUFACTURING, Heyburn, ID (US)

(21) Appl. No.: 17/834,823

(22) Filed: Jun. 7, 2022

(51) Int. Cl. A01D 90/02; A01D 13/00; A01D 33/12; A01D 90/10

(52) U.S. Cl. CPC A01D 90/02; A01D 13/00; A01D 33/12; A01D 90/10

(57) ABSTRACT

A method of transitioning a first truck and a second truck during harvesting using a harvesting system. The harvesting system includes a vehicle and a harvester and the harvester includes a plow, an elevator, a table, and a boom. The vehicle includes a power take off. The method includes turning on, by the operator, at least one of the table and the boom. The method also includes selecting, by the operator, an operating speed of the boom. The method further includes turning off, by the operator, at least one of the table and the boom. The method also includes depositing potatoes in the first truck.

### TECHNICAL FIELD

The present disclosure relates generally to harvesting crops, and more particularly relates to systems and methods for truck transitions during harvesting.

### BACKGROUND

A harvesting system typically includes a vehicle and a harvester pulled by the vehicle. The harvester typically includes a plow, an elevator, a table, a boom, and a plurality of other components. The harvester is typically pulled by the vehicle and the plow extracts potatoes from the ground. When harvesting crops, such as, but not limited to, root vegetables, the plow transfers the root vegetables, such as in some instances, potatoes, to the elevator and the elevator transports the root vegetables from the plow to the table. The table transports the potatoes to the boom and the boom transfers the potatoes from the harvester to a truck that is proximate the harvester by dropping the potatoes into the back of the truck. When the truck is full, the harvester typically stops and waits for another truck to position itself proximate the boom to receive potatoes. The harvester then begins plowing again. This process is known as truck transition and is an inefficient process that increases harvesting time and decreases profits. Restarting a harvester consumes a larger amount of fuel than simply continuing to plow. Thus, stopping, waiting for a truck to position itself near the boom, restarting the harvester and resuming the harvest is energy inefficient and wastes time.

For at least the foregoing reasons, there is a need to provide improved methods of truck transfer that may reduce fuel consumption, reduce transfer time, and/or increase profits.

### SUMMARY

One aspect of the present disclosure relates to a method of transitioning a first truck and a second truck during harvesting using a harvesting system. The harvesting system includes a vehicle and a harvester and the harvester includes a plow, an elevator, a table, and a boom. The vehicle includes a power take off. The method includes turning on, by the operator, at least one of the table and the boom. The method also includes selecting, by the operator, an operating speed of the boom. The method further includes turning off, by the operator, at least one of the table and the boom. The method also includes depositing potatoes in the first truck.

Another aspect of the present disclosure relates to a method of transitioning a first truck and a second truck during harvesting using a harvesting system. The harvesting system includes a vehicle and a harvester and the harvester includes a plow, an elevator, a table, and a boom. The vehicle includes a power take off. The method includes turning on, by the operator, the power take off. The method also includes automatically turning on, by the harvesting system, the harvester based on the power take off turning on. The method further includes selecting, by the operator, an operating speed of the boom. The method also includes turning off, by the operator, the power take off. The method further includes automatically turning off, by the harvesting system, the harvester based on the power take off turning off. The method also includes depositing potatoes in the first truck.

The present disclosure is further directed to a method of transitioning a first truck and a second truck during harvesting using a harvesting system. The harvesting system includes a vehicle and a harvester and the harvester includes a plow, an elevator, a table, and a boom. The vehicle includes a power take off. The method includes automatically controlling, by the harvesting system, the boom to empty the boom into the first truck. The method also includes automatically controlling, by the harvesting system, the boom to at least partially fill at least one of the table and the boom. The method further includes positioning a second truck proximate the boom. The method also includes automatically controlling, by the harvesting system, the boom to at least partially fill the second truck.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the embodiments may be realized by reference to the following drawings. In the appended figures, similar components or features may have the same reference label.

FIG. 1 is a perspective view of an example harvesting system in accordance with the present disclosure.

FIG. 2 is a perspective view of an example harvester system in accordance with the present disclosure.

FIG. 3 is another perspective view of an example harvester in accordance with the present disclosure.

FIG. 4 is a perspective view of a table of a harvester in accordance with the present disclosure.

FIG. 5 illustrates a flow diagram of a method of transitioning a truck in accordance with the present disclosure.

FIG. 6 illustrates another flow diagram of a method of transitioning a truck in accordance with the present disclosure.

FIG. 7 illustrates another flow diagram of a method of transitioning a truck in accordance with the present disclosure.

FIG. 8 illustrates another flow diagram of a method of transitioning a truck in accordance with the present disclosure.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

Embodiments of the present disclosure include methods and systems for truck transitions during harvesting. More specifically, embodiments of the present disclosure include methods and systems for truck transitions during harvesting of root vegetables such as, without limitation, potatoes. Harvesters typically include a plow, an elevator, a table, a boom, and many other components. The harvesters are typically pulled by another vehicle, such as, but not limited to, a tractor, and the plow extracts the potatoes from the ground as the vehicle pulls the harvester. The elevator transports the potatoes from the elevator to the table and the table transports the potatoes to the boom. The boom transfers the potatoes from the harvester to a truck that is proximate the harvester by dropping the potatoes into the back of the truck. When the truck is full, the harvester typically stops and waits for another truck to position itself proximate the boom to receive the potatoes. The harvester then begins plowing again. This process is known as truck transition and is an inefficient process that increases harvesting time and decreases profits. Restarting a harvester consumes increased amounts of fuel compared to continuing to plow. Thus, stopping, waiting for a truck to position itself near the boom, and restarting is energy inefficient and wastes time.

The systems and methods described herein may reduce or eliminate the inefficiencies of truck transition by managing the operation of the table and the boom during truck transition. Specifically, the systems and methods described herein turn the boom off such that potatoes accumulate in the table such that potatoes do not fall off of the harvester during truck transition. The harvester continues plowing the potatoes and a new truck positions itself proximate the boom while the harvester is moving and plowing. The system turns the boom back on and the potatoes begin dropping into the back of the truck. As such, the systems and methods described herein enable the harvester to continue operating during truck transition, potentially decreasing waiting time, decreasing fuel consumption, and increasing profits.

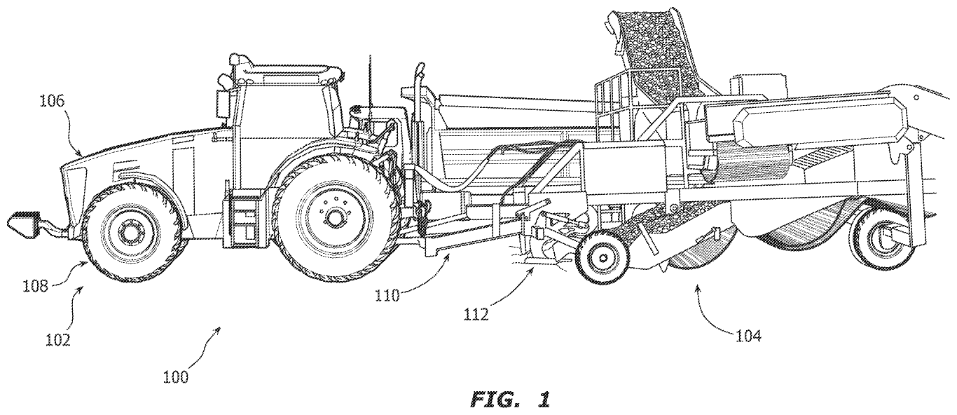

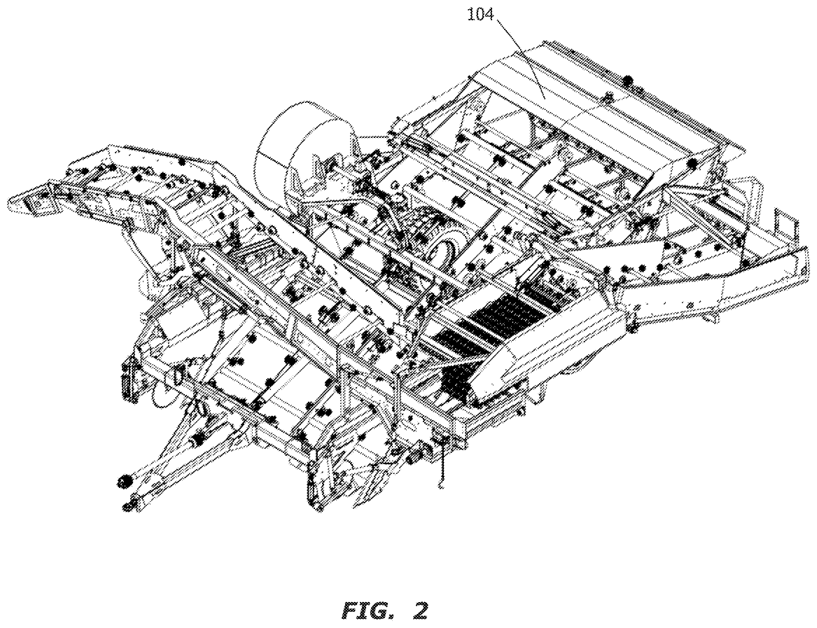

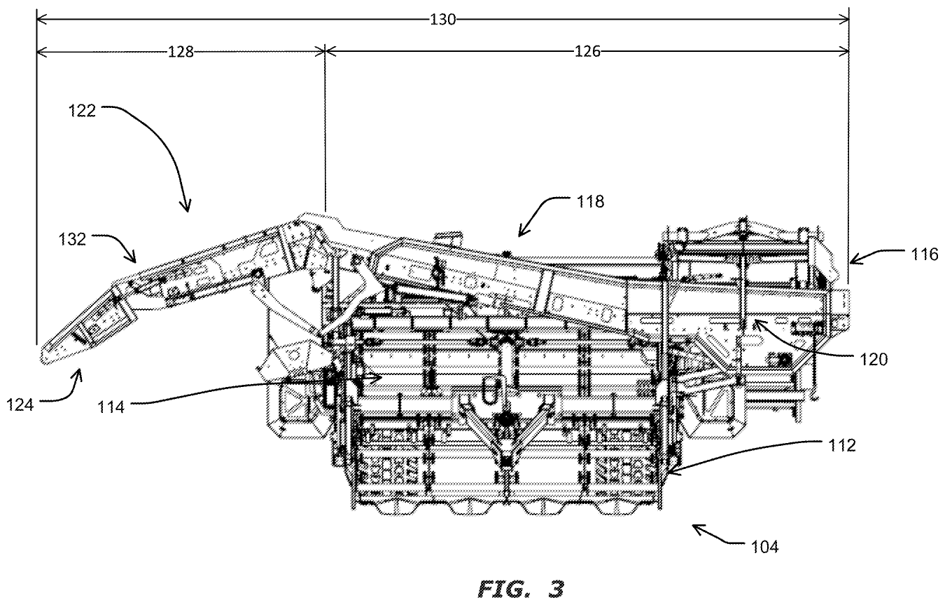

FIG. 1 illustrates a system 100 for harvesting vegetables, such as, but not limited to, potatoes. The system 100 includes a vehicle 102 and a harvester 104. In the illustrated embodiment, the vehicle 102 is a tractor and the harvester 104 is a potato harvester removably attached to the vehicle 102. That is, in the illustrated embodiment, the vehicle 102 and the harvester 104 are separate components and the vehicle 102 pulls the harvester 104 during operations. In alternative embodiments, the vehicle 102 may be any type of vehicle that enables the systems and methods to operate as described herein and the harvester 104 may be any type of harvester configured to harvest any type of vegetable that enables the systems and methods described herein to operate as described herein. For example, in some embodiments, the vehicle 102 and the harvester 104 may be combined into a single self-propelled harvesting machine. FIG. 2 and FIG. 3 provide alternate perspective views of the system 100.

The vehicle 102 includes a motor 106, wheels 108, and a power take off (PTO) 110. The motor 106 powers the wheels 108 to propel the vehicle 102 and the harvester 104 forward. Additionally, the motor 106 powers the power take off 110, which is attached to the harvester 104. The power take off 110 is attached to a corresponding shaft (not shown) on the harvester 104 and rotation of the power take off 110 rotates the corresponding shaft. The corresponding shaft powers portions of the harvester 104 as described below. Thus, the vehicle 102 provides motive force for the harvester 104 to move the harvester 104 through the crop field and provides power to operate portions of the harvester 104.

The harvester 104 includes a plow 112, an elevator 114, a table 116, a boom 118, and a plurality of other components. The harvester 104 is pulled by the vehicle 102 and the plow 112 extracts potatoes from the ground. The plow 112 transfers the potatoes to the elevator 114 and the elevator 114 transports the potatoes from the plow 112 to the table 116. The table 116 transports the potatoes to the boom 118 and the boom 118 transfers the potatoes from the harvester 104 to a truck (not shown) that is proximate the harvester 104 by dropping the potatoes into the back of the truck. When the truck is full, the harvester 104 typically stops and waits for another truck to position itself proximate the boom 118 to receive the potatoes. The harvester 104 then begins plowing again. This process is known as truck transition and is an inefficient process that increases harvesting time and decreases profits. In alternative embodiments, the harvester 104 may be any type of harvester that includes any components that enable the system 100 to operate as described herein.

In the illustrated embodiment, the boom 118 has an inner boom 120 and an outer boom 122. The inner boom 120 is pivotably attached to the table 116 and the outer boom 122 is pivotably attached to the inner boom 120. Specifically, the inner boom 120 and the outer boom 122 are capable of pivoting to raise or lower an end 124 of the outer boom 122 above the back of the truck in order to drop potatoes into the back of the truck. Additionally, pivoting the inner boom 120 and the outer boom 122 can enable the boom 118 to receive additional potatoes from the table 116 during truck transition in order to reduce or prevent potatoes from falling off the boom 118 while the harvester 104 continues to harvest potatoes and a new truck positions itself proximate the boom 118.

Additionally, the inner boom 120 has an inner boom length 126 and the outer boom 122 has an outer boom length 128. The boom 118 has a boom length 130 that is the combined length of the inner boom length 126 and the outer boom length 128. The inner boom 120 and the outer boom 122 each include a plurality of conveyors 132 that are hydraulically powered on a dedicated boom power circuit (not shown). The dedicated boom power circuit is powered directly or indirectly by power take off 110 and the vehicle 102. The dedicated boom power circuit may be shut off independently of other components of the harvester 104 by shutting off the dedicated boom power circuit. In alternative embodiments, the boom 118 may be any type of boom including any components that enable the harvester 104 to operate as described herein. Additionally, in alternative embodiments, the boom 118 may be powered by any system that enables the harvester 104 to operate as described herein.

The dedicated boom power circuit may be modulated to power the conveyors 132 of both the inner boom 120 and the outer boom 122 at varying speeds. Specifically, the conveyors 132 typically operate at a predetermined speed measured in rotations per minute. That is, the conveyors 132 rotate about a plurality of bearings (not shown) and the number of rotations the conveyors 132 complete per minute (or other unit of time) determines how fast the conveyor is rotating and how fast the potatoes are traveling from the table 116 to the end 124 of the boom 118. The system 110 described herein calculates the amount of time it takes the potatoes to travel from the table 116 to the end 124 of the boom 118 based on the boom length 130 and the rotations per minute of the conveyors 132.

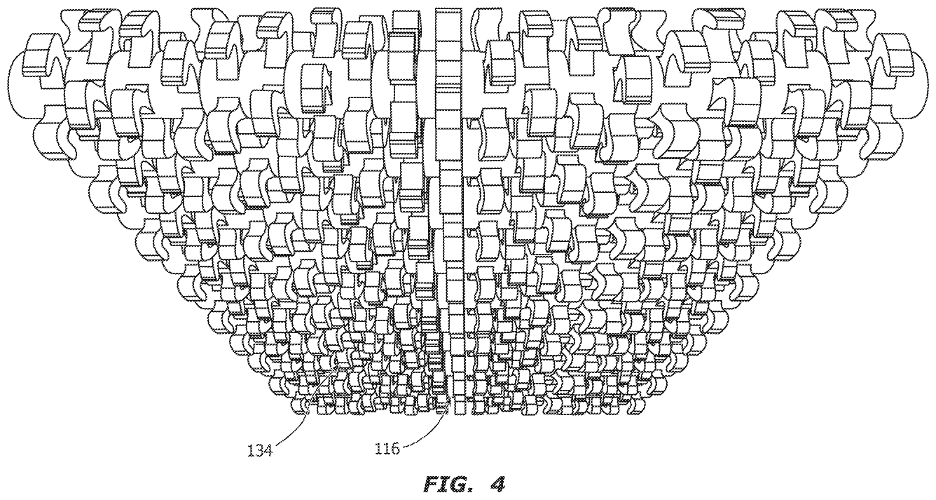

In the illustrated embodiment, as seen in FIG. 4, the table 116 includes a plurality of rollers 134 that are configured to transport the potatoes through the table 116 to the boom 118. The rollers 134 also assist with separating the potatoes from the soil. The rollers 134 are hydraulically powered on a dedicated table power circuit (not shown). The dedicated table power circuit is powered directly or indirectly by power take off 110 and the vehicle 102. The dedicated table power circuit may be shut off independently of other components of the harvester 104 by shutting off the dedicated table power circuit. In alternative embodiments, the table 116 may be any type of table including any components that enable the harvester 104 to operate as described herein. Additionally, in alternative embodiments, the table 116 may be powered by any system that enables the harvester 104 to operate as described herein.

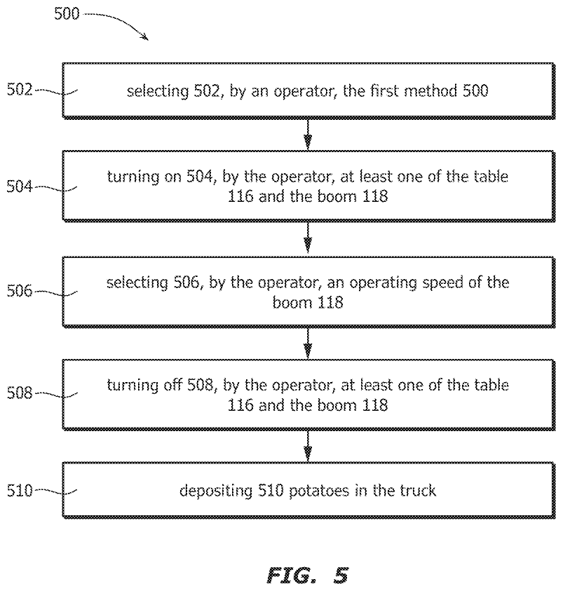

FIG. 5 is a flow diagram of a first method 500 of transitioning a truck. The method 500 includes 502, selecting, by an operator, the first method 500; 504, turning on, by the operator, at least one of the table 116 and/or the boom 118; 506, selecting, by the operator, an operating speed of the boom 118; 508, turning off, by the operator, at least one of the table 116 and/or the boom 118; and 510, depositing potatoes in the truck. The first method 500 may include additional steps not outlined herein.

The operator of the system 100 may be, and is typically the driver of the vehicle 102 and the operator is typically equipped with an electronic device that is capable of controlling truck transition. In the illustrated embodiment, the electronic device is a tablet capable of controlling truck transition. That is, the tablet includes software that interfaces with at least one of the vehicle 102 and the harvester 104 to control truck transition. In alternative embodiments, the electronic device may be any device that is capable of controlling truck transition as described herein. For example, the electronic device may be a smart phone, a laptop computer, and/or any other device that is capable of controlling truck transition as described herein. In another alternative embodiment, the electronic device may be integrated into the vehicle 102 and/or the harvester 104.

During the first method 500, the operator uses the electronic device to select 502 the first method 500 of controlling truck transition. The first method 500 may also be known as button truck transition. In the first method 500, the operator directly controls the operation of the table 116 and the boom 118 by turning the table 116 and the boom 118 off and on using a button on the electronic device. The button may be a physical button or a digital button on a screen of the electronic device. By directly controlling the table 116 and the boom 118, the operator can prevent potatoes from dropping off the boom 118 while still plowing with the plow 112.

Specifically, during harvesting and when a truck is proximate the boom 118, the operator turns on at least one of the table 116 and the boom 118 such that potatoes drop into the back of the truck. In the illustrated embodiment, the operator turns on both the table 116 and the boom 118 such that potatoes drop into the back of the truck. When the truck is not proximate the boom 118, the operator turns off at least one of the table 116 and the boom 118 such that potatoes are not dropped off the boom 118 onto the ground. In the illustrated embodiment, when the truck is not proximate the boom 118, the operator turns off both of the table 116 and the boom 118 such that potatoes are not dropped off the boom 118 onto the ground. The vehicle 102 continues to pull the harvester 104 such that potatoes are continuously plowed, reducing or eliminating stops due to truck transfer. The plowed potatoes accumulate in at least one of the table 116 and the boom 118 such that potatoes are not dropped off the boom 118 onto the ground. Once a new truck is proximate the boom 118, the operator turns on at least one of the table 116 and the boom 118 such that potatoes drop into the back of the new truck. In the illustrated embodiment, the operator turns on both the table 116 and the boom 118 such that potatoes drop into the back of the new truck.

Additionally, the operator may control the rotational speed of the boom 118 to prevent or reduce the loss of potatoes while continuing to plow during truck transition. For example, in addition to or instead of turning off at least one of the table 116 and the boom 118 such that potatoes are not dropped off the boom 118 onto the ground when a truck is not proximate the boom 118, the operator may reduce the speed of the boom 118 such that potatoes are not dropped off the boom 118 onto the ground when a truck is not proximate the boom 118. For example, if a new truck is near the system 100 while a truck is being loaded with potatoes, the operator may continue to operate the boom 118 and the table 116. However, the operator may operate the boom 118 at a reduced rotational speed to reduce or prevent potatoes from dropping on the ground while the new truck transitions into position. Because the new truck is close to the system 100, reducing the rotational speed of the boom 118 may be sufficient to reduce or prevent potatoes from dropping on the ground while the new truck transitions into position.

The operator may also use a combination of turning off at least one of the table 116 and the boom 118 and reducing the rotational speed of the boom 118 to reduce or prevent potatoes from dropping on the ground while the new truck transitions into position. For example, in the beginning of truck transition, the operator may turn off at least one of the table 116 and the boom 118 at the beginning of truck transition. Then, once the table 116 begins to fill up with potatoes, the operator may turn on the table 116 and the boom 118 at reduced speeds as described above to reduce or prevent potatoes from dropping on the ground while the new truck transitions into position. The combination of turning off at least one of the table 116 and the boom 118 and reducing the rotational speed of the boom 118 increases the volume of potatoes that can be stored in the harvester 104 during truck transition by using the boom 118 as additional storage space for the potatoes. The combination increases the amount of time the operator has for truck transition and increases the amount of time a new truck has to position itself proximate the boom 118. In an alternative embodiment, the first method 500 of truck transition may also include turning off the harvester 104 if a new truck is not proximate the boom 118.

The first method 500 of truck transition enables the operator to control the operation of the table 116 and the boom 118 to reduce or prevent potatoes from dropping on the ground while the new truck transitions into position and the harvesting system 100 continues to plow potatoes. Specifically, the first method 500 of truck transition enables the operator to turn off at least one of the table 116 and the boom 118 and reduce the rotational speed of the boom 118 to reduce or prevent potatoes from dropping on the ground while the new truck transitions into position and the harvesting system 100 continues to plow potatoes. Additionally, the first method 500 of truck transition enables the operator to employ a combination of turning off at least one of the table 116 and the boom 118 and reducing the rotational speed of the boom 118 to reduce or prevent potatoes from dropping on the ground while the new truck transitions into position and the harvesting system 100 continues to plow potatoes. Accordingly, the first method 500 of truck transition may decrease fuel consumption, decrease harvesting time, and increase profits.

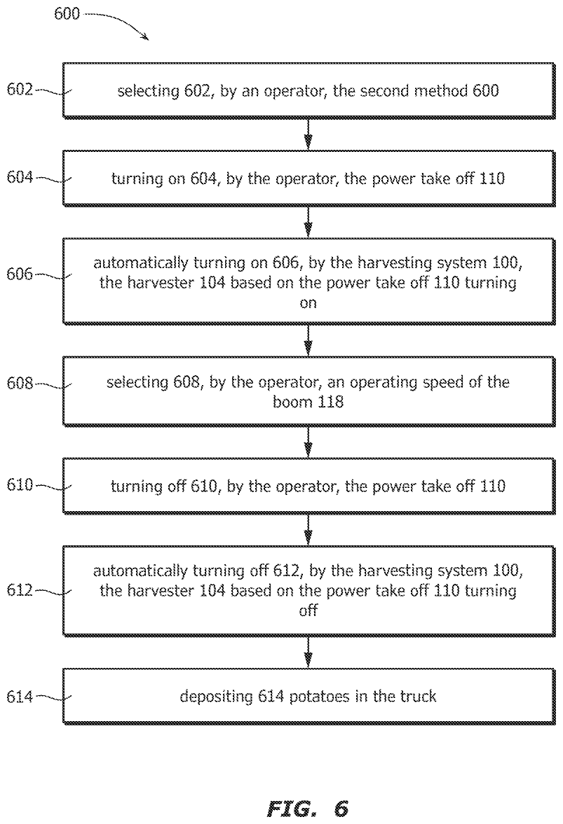

FIG. 6 is a flow diagram of a second method 600 of transitioning a truck. The method 600 includes 602, selecting, by an operator, the second method 600; 604, turning on, by the operator, the power take off 110; 606, automatically turning on, by the harvesting system 100, at least one of the table 116 and the boom 118 based on the power take off 110 turning on; 608, selecting, by the operator, an operating speed of the boom 118; 610, turning off, by the operator, the power take off 110; 612, automatically turning off, by the harvesting system 100, the harvester 104 based on the power take off 110 turning off; and 614, depositing potatoes in the truck. The second method 600 may include additional steps not outlined herein.

The operator of the system 100 is typically the driver of the vehicle 102 and the operator is typically equipped with an electronic device that is capable of controlling truck transition. In the illustrated embodiment, the electronic device is a tablet capable of controlling truck transition. That is, the tablet includes software that interfaces with at least one of the vehicle 102 and the harvester 104 to control truck transition. In alternative embodiments, the electronic device may be any device that is capable of controlling truck transition as described herein. For example, the electronic device may be a smart phone, a laptop computer, and/or any other device that is capable of controlling truck transition as described herein. In another alternative embodiment, the electronic device may be integrated into the vehicle 102 and/or the harvester 104.

During the second method 600, the operator uses the electronic device to select 602 the second method 600 of controlling truck transition. The second method 600 may also be known as power take off (PTO) transition. In the second method 600, the operator directly controls the operation of the harvester 104 by turning the PTO 110 off and on using a button on the electronic device. The harvesting system 100 detects that the PTO 110 has been turned off or on and automatically turns off or on the harvester 104. The button may be a physical button or a digital button on a screen of the electronic device. By directly controlling the harvester 104, the operator is capable of preventing potatoes from dropping off the boom 118 during truck transition by stopping harvesting of potatoes during truck transition.

Specifically, during harvesting and when a truck is proximate the boom 118, the operator turns on the PTO 110 and the harvester 104 automatically turns on at least one of the table 116 and the boom 118 such that potatoes drop into the back of the truck. In the illustrated embodiment, the operator turns on the PTO 110 and the harvester 104 automatically turns on both the table 116 and the boom 118 such that potatoes drop into the back of the truck. When the truck is not proximate the boom 118, the operator turns off the PTO 110 and the harvester 104 automatically turns off such that the harvester 104 is no longer plowing potatoes and potatoes are not dropped off the boom 118 onto the ground. The vehicle 102 stops pulling the harvester 104 to allow a new truck to position itself proximate the boom 118. The plowed potatoes accumulate in at least one of the table 116 and the boom 118 such that potatoes are not dropped off the boom 118 onto the ground. Once a new truck is proximate the boom 118, the operator turns on the PTO 110 and the harvester 104 automatically turns on such that potatoes drop into the back of the new truck.

Additionally, the operator may control the rotational speed of the boom 118 to prevent or reduce the loss of potatoes while continuing to plow during truck transition. For example, in addition to or instead of turning off at least one of the table 116 and the boom 118 such that potatoes are not dropped off the boom 118 onto the ground when a truck is not proximate the boom 118, the operator may reduce the speed of the boom 118 such that potatoes are not dropped off the boom 118 onto the ground when a truck is not proximate the boom 118. For example, if a new truck is near the system 100 while a truck is being loaded with potatoes, the operator may continue to operate the boom 118 and the table 116. However, the operator may operate the boom 118 at a reduced rotational speed to reduce or prevent potatoes from dropping on the ground while the new truck transitions into position. Because the new truck is close to the system 100, reducing the rotational speed of the boom 118 may be sufficient to reduce or prevent potatoes from dropping on the ground while the new truck transitions into position.

The operator may also use a combination of turning off the PTO 110 and reducing the rotational speed of the boom 118 to reduce or prevent potatoes from dropping on the ground while the new truck transitions into position. For example, in the beginning of truck transition, the operator may turn off the PTO 110 and the harvester 104 may automatically turn off at the beginning of truck transition. Then the operator may turn on the PTO 110 and the harvester 104 may automatically turn on the table 116 and the boom 118 at reduced speeds as described above to reduce or prevent potatoes from dropping on the ground while the new truck transitions into position. The combination of turning off the PTO 110 and reducing the rotational speed of the boom 118 increases the volume of potatoes that can be stored in the harvester 104 during truck transition by using the boom 118 as additional storage space for the potatoes. The combination increases the amount of time the operator has for tuck transition and increases the amount of time a new truck has to position itself proximate the boom 118.

The harvester 104 may detect the operational status of the PTO 110 using a variety of different detection methods. For example, the harvester 104 may include microphones that listen for the PTO 110. In alternative embodiments, the harvester 104 may include listening to CANbus, specifically the ISObus network, which is a hexadecimal address and message that transmits the PTO 110 on/off and the PTO 110 speed signals which is the same on all J1939 protocol machines. The J1939 protocol specifies the address for everything from the engine RPM's, brake lights, and the PTO 110 RPM. The PTO 110 may also be monitored with a tone wheel and impedance sensor.

The second method 600 of truck transition enables the operator to control the operation of the PTO 110 and the harvester 104 to reduce or prevent potatoes from dropping on the ground while the new truck transitions into position and the harvesting system 100 continues to plow potatoes. Specifically, the second method 600 of truck transition enables the operator to turn off the harvester 104 by turning off the PTO 110 and reduce the rotational speed of the boom 118 to reduce or prevent potatoes from dropping on the ground while the new truck transitions into position. Additionally, the second method 600 of truck transition enables the operator to employ a combination of turning off the harvester 104 by turning off the PTO 110 and reducing the rotational speed of the boom 118 to reduce or prevent potatoes from dropping on the ground while the new truck transitions into position. Moreover, the second method 600 of truck transition simplifies the process of the first method 500 by enabling the operator to control the truck transition process with a single button or control. Accordingly, the second method 600 of truck transition may decrease fuel consumption, decrease harvesting time, and/or increase profits.

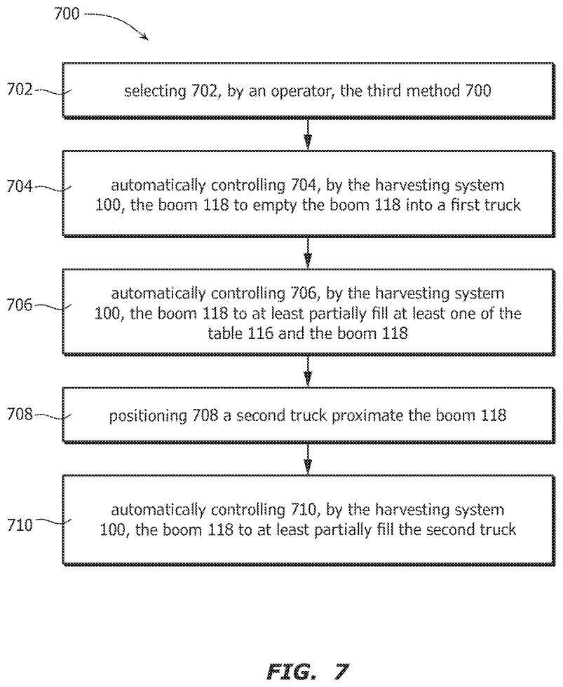

FIG. 7 is a flow diagram of a third method 700 of transitioning a truck. The method 700 includes 702, selecting, by an operator, the third method 700; 704, automatically controlling, by the harvesting system 100, the boom 118 to empty the boom 118 into a first truck; 706, automatically controlling, by the harvesting system 100, the boom 118 to at least partially fill at least one of the table 116 and the boom 118; 708 positioning a second truck proximate the boom 118; and 710, automatically controlling, by the harvesting system 100, the boom 118 to at least partially fill the second truck. The third method 700 may include additional steps not outlined herein.

The operator of the system 100 is typically the driver of the vehicle 102 and the operator is typically equipped with an electronic device that is capable of controlling truck transition. In the illustrated embodiment, the electronic device is a tablet capable of controlling truck transition. That is, the tablet includes software that interfaces with at least one of the vehicle 102 and the harvester 104 to control truck transition. In alternative embodiments, the electronic device may be any device that is capable of controlling truck transition as described herein. For example, the electronic device may be a smart phone, a laptop computer, and/or any other device that is capable of controlling truck transition as described herein.

During the third method 700, the operator uses the electronic device to select 702 the third method 700 of controlling truck transition. The third method 700 may also be known as runout transition. In the third method 700, the operator selects the third method 700 by selecting a button and the harvester 104 directly controls the operation of the table 116 and the boom 118. The button may be a physical button or a digital button on a screen of the electronic device. By selecting the third method 700, the operator enables the harvester 104 to control truck transition to prevent potatoes from dropping off the boom 118 while still plowing with the plow 112.

Specifically, during harvesting and when a truck is proximate the boom 118, the operator turns on the third method 700 and the harvester 104 automatically controls at least one of the table 116 and the boom 118 such that potatoes drop into the back of the first truck. In the illustrated embodiment, upon selection of the third method 700, the harvester 104 resets a boom distance counter that calculates the distance the boom 118 has traveled. The harvester 104 then sets the boom rotational speed to a predetermined boom empty speed. The harvester 104 then automatically turns off at least one of the table 116, the inner boom 120, and the outer boom 122 to enable potatoes to accumulate in the table 116 and/or the boom 118. The harvester 104 also turns on a first signal that signals the second truck to wait for the first truck to finish being loaded before positioning itself proximate the boom 118.

The harvester 104 detects that the boom 118 is empty by calculating the distance the boom 118 has traveled since the boom distance counter was reset. Specifically, in the illustrated embodiment, the boom length 130 is calibrated in the harvesting system 100 prior to harvesting. The harvester 104 calculates the distance the boom 118 has traveled based on the calibrated boom length 130 and the rotational speed of the boom 118. In alternative embodiments, the harvester 104 may determine that the boom 118 is empty in any manner that enables the harvester 104 to operate as described herein. For example, the harvester 104 by be programmed to turn off the boom 118 after a predetermined amount of time that ensures the boom 118 is empty. In another alternative embodiment, the boom 118 may include sensors that detect potatoes in the boom 118.

Once the boom 118 is empty, the first truck moves way from the boom 118 and the harvester 104 turns off the first signal and turns on a second signal. The second signal summons the second truck to positioning itself proximate the boom 118. The harvester 104 also resets the boom distance counter that calculates the distance the boom 118 has traveled. The harvester 104 then sets the boom rotational speed to a predetermined boom fill speed. The boom 118 fills the second truck with potatoes by dropping the potatoes into the back of the second truck.

The harvester 104 detects that the back of the second truck is full by calculating the distance the boom 118 has traveled since the boom distance counter was reset. Specifically, in the illustrated embodiment, the boom length 130 is calibrated in the harvesting system 100 prior to harvesting. The harvester 104 calculates the distance the boom 118 has traveled based on the calibrated boom length 130 and the rotational speed of the boom 118. In alternative embodiments, the harvester 104 may determine that the boom 118 is empty in any manner that enables the harvester 104 to operate as described herein. For example, the harvester 104 by be programmed to turn off the boom 118 after a predetermined amount of time that ensures the back of the second truck is full. In another alternative embodiment, the boom 118 may include sensors that detect potatoes in the back of the second truck. Once the back of the second truck is full, the second truck moves way from the boom 118 and the harvester 104 turns off the first signal and the second signal. The harvester 104 turns off the third method 700 and operations of the harvesting system 100 return to normal.

The third method 700 enables the harvester 104 to automatically control truck transition. Specifically, the harvester 104 automatically turns on both the table 116 and the boom 118 such that potatoes drop into the back of the truck. When the truck is not proximate the boom 118, the harvester 104 automatically turns off at least one of the table 116 and the boom 118 such that potatoes are not dropped off the boom 118 onto the ground. In the illustrated embodiment, when the truck is not proximate the boom 118, the harvester 104 automatically turns off both of the table 116 and the boom 118 such that potatoes are not dropped off the boom 118 onto the ground. The vehicle 102 continues to pull the harvester 104 such that potatoes are continuously plowed, reducing or eliminating stops due to truck transfer. The plowed potatoes accumulate in at least one of the table 116 and the boom 118 such that potatoes are not dropped off the boom 118 onto the ground. Once a new truck is proximate the boom 118, the harvester 104 automatically turns on at least one of the table 116 and the boom 118 such that potatoes drop into the back of the new truck. In the illustrated embodiment, the harvester 104 automatically turns on both the table 116 and the boom 118 such that potatoes drop into the back of the new truck.

Additionally, the operator may control the rotational speed of the boom 118 to prevent or reduce the loss of potatoes while continuing to plow during truck transition. Specifically, the operator may control or set at least one of the predetermined boom fill speed and the predetermined boom empty speed to provide more or less time during truck transition. For example, the operator may want more time during truck transition and may decrease at least one of the predetermined boom empty speed and the predetermined boom empty speed to 50% of full operating speed of the boom 118. Alternatively, the operator may want to speed up truck transition and may increase at least one of the predetermined boom empty speed and the predetermined boom empty speed to 90% or 100% of full operating speed of the boom 118.

Additionally, the harvester 104 may automatically control the rotational speed of the boom 118 to prevent or reduce the loss of potatoes while continuing to plow during truck transition. For example, in addition to or instead of turning off at least one of the table 116 and the boom 118 such that potatoes are not dropped off the boom 118 onto the ground when a truck is not proximate the boom 118, the harvester 104 may automatically reduce the speed of the boom 118 such that potatoes are not dropped off the boom 118 onto the ground when a truck is not proximate the boom 118. For example, if a new truck is near the system 100 while a truck is being loaded with potatoes, the harvester 104 may automatically continue to operate the boom 118 and the table 116. However, the harvester 104 may automatically operate the boom 118 at a reduced rotational speed to reduce or prevent potatoes from dropping on the ground while the new truck transitions into position. Because the new truck is close to the system 100, reducing the rotational speed of the boom 118 may be sufficient to reduce or prevent potatoes from dropping on the ground while the new truck transitions into position.

The harvester 104 may also use a combination of controlling the boom 118 and the table 116 and reducing the rotational speed of the boom 118 to reduce or prevent potatoes from dropping on the ground while the new truck transitions into position. For example, in the beginning of truck transition, the harvester 104 may automatically turn off at least one of the table 116 and the boom 118 at the beginning of truck transition. Then, once the table 116 begins to fill up with potatoes, the harvester 104 may automatically turn on the table 116 and the boom 118 at reduced speeds as described above to reduce or prevent potatoes from dropping on the ground while the new truck transitions into position. The combination of controlling the boom 118 and the table 116 and reducing the rotational speed of the boom 118 increases the volume of potatoes that can be stored in the harvester 104 during truck transition by using the boom 118 as additional storage space for the potatoes. The combination increases the amount of time the operator has for tuck transition and increases the amount of time a new truck has to position itself proximate the boom 118.

The third method 700 of truck transition enables the harvester 104 to control the operation of the table 116 and the boom 118 to reduce or prevent potatoes from dropping on the ground while the new truck transitions into position and the harvesting system 100 continues to plow potatoes. Specifically, the third method 700 of truck transition enables the harvester 104 to turn off at least one of the table 116 and the boom 118 and reduce the rotational speed of the boom 118 to reduce or prevent potatoes from dropping on the ground while the new truck transitions into position and the harvesting system 100 continues to plow potatoes. Additionally, the third method 700 of truck transition enables the harvester 104 to employ a combination of turning off at least one of the table 116 and the boom 118 and reducing the rotational speed of the boom 118 to reduce or prevent potatoes from dropping on the ground while the new truck transitions into position and the harvesting system 100 continues to plow potatoes. Accordingly, the third method 700 of truck transition decreases fuel consumption, decreases harvesting time, and increases profits.

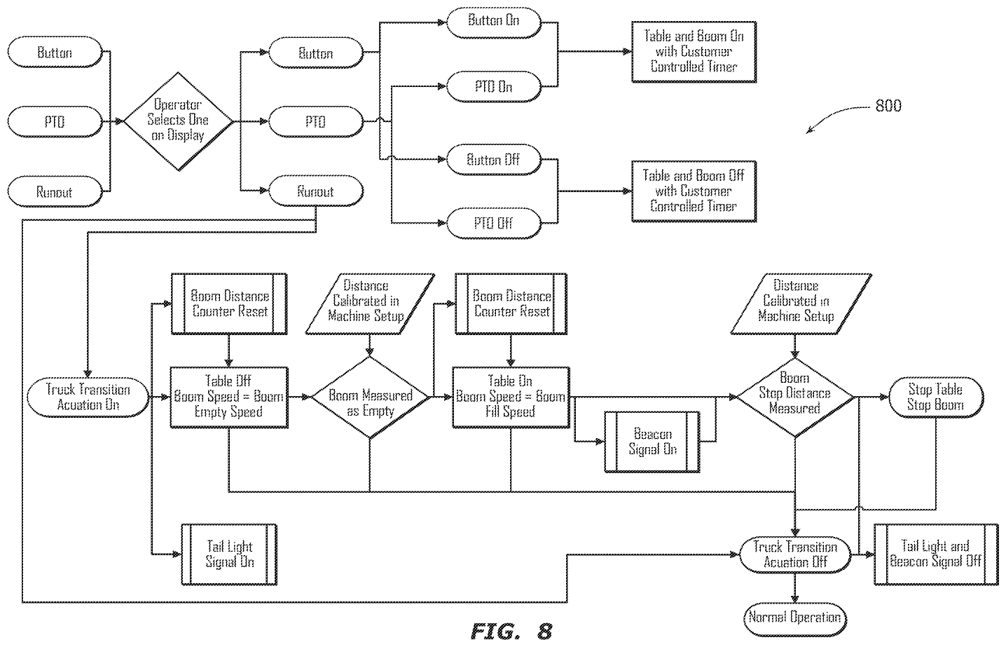

FIG. 8 is a simplified flow diagram 800 of the first, second, and third methods 500, 600, and 700. As shown in FIG. 8, the operator selects which method to use and the harvesting system 100 responds accordingly. Additionally, as shown in FIG. 8, the operator may use the electronic device to switch between methods. That is, the operator may start the truck transition using the third method 700 and then may switch to the first or second methods 500 and 600 midway through the truck transition.

Embodiments of the present disclosure include methods and systems for truck transitions during harvesting. More specifically, embodiments of the present disclosure include methods and systems for truck transitions during harvesting of potatoes. Harvesters typically include a plow, an elevator, a table, a boom, and many other components. The harvesters are typically pulled by another vehicle, such as, but not limited to, a tractor, and the plow extracts the potatoes from the ground as the vehicle pulls the harvester. The elevator transports the potatoes from the elevator to the table and the table transports the potatoes to the boom. The boom transfers the potatoes from the harvester to a truck that is proximate the harvester by dropping the potatoes into the back of the truck. When the truck is full, the harvester typically stops and waits for another truck to position itself proximate the boom to receive the potatoes. The harvester then begins plowing again. This process is known as truck transition and is an inefficient process that increases harvesting time and decreases profits. Restarting a harvester consumes increased amounts of fuel compared to continuing to plow. Thus, stopping, waiting for a truck to position itself near the boom, and restarting is energy inefficient and wastes time.

The systems and methods described herein reduce or eliminate the inefficiencies of truck transition by managing the operation of the table and the boom during truck transition. Specifically, the systems and methods described herein turn the boom off such that potatoes accumulate in the table such that potatoes do not fall off of the harvester during truck transition. The harvester continues plowing the potatoes and a new truck positions itself proximate the boom while the harvester is moving and plowing. The system turns the boom back on and the potatoes begin dropping into the back of the truck. As such, the systems and methods described herein enable the harvester to continue operating during truck transition, decreasing waiting time, decreasing fuel consumption, and increasing profits.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.” In addition, the term “based on” as used in the specification and the claims is to be construed as meaning “based at least upon.”

1. A method of transitioning a first truck and a second truck during harvesting using a harvesting system, the harvesting system comprising a vehicle and a harvester, the harvester comprising a plow, an elevator, a table, and a boom, the vehicle comprising a power take off, the method comprising:
turning on, by the operator, the table and the boom;
selecting, by the operator, an operating speed of the boom;
depositing potatoes in the first truck;
turning off, by the operator, the table and the boom; and
depositing potatoes in the second truck.

2-3. (canceled)

4. The method of claim 1, further comprising:
turning on, by the operator, at least one of the table and the boom;
selecting, by the operator, an operating speed of the boom;
turning off, by the operator, at least one of the table and the boom.

5. The method of claim 4, wherein turning off, by the operator, at least one of the table and the boom comprises turning off, by the operator, the table and the boom.

6. The method of claim 4, wherein turning on, by the operator, at least one of the table and the boom comprises turning on, by the operator, the table and the boom.

7. The method of claim 1, wherein selecting, by the operator, an operating speed of the boom comprises reducing the operating speed of the boom.

8. A method of transitioning a first truck and a second truck during harvesting using a harvesting system, the harvesting system comprising a vehicle and a harvester, the harvester comprising a plow, an elevator, a table, and a boom, the vehicle comprising a power take off, the method comprising:
turning on, by the operator, the power take off;
automatically turning on, by the harvesting system, the harvester based on the power take off turning on;
selecting, by the operator, an operating speed of the boom;
turning off, by the operator, the power take off;
automatically turning off, by the harvesting system, the harvester based on the power take off turning off; and
depositing potatoes in the first truck.

9. The method of claim 8, wherein automatically turning on, by the harvesting system, the harvester based on the power take off turning on comprises automatically turning on, by the harvesting system, the table, the boom, the elevator, and the plow based on the power take off turning on.

10. The method of claim 8, wherein automatically turning off, by the harvesting system, the harvester based on the power take off turning off comprises automatically turning off, by the harvesting system, the table, the boom, the elevator, and the plow based on the power take off turning off.

11. The method of claim 8, further comprising:
turning on, by the operator, the power take off;
automatically turning on, by the harvesting system, the harvester based on the power take off turning on;
selecting, by the operator, an operating speed of the boom;
turning off, by the operator, the power take off;
automatically turning off, by the harvesting system, the harvester based on the power take off turning off; and
depositing potatoes in the second truck.

12. The method of claim 11, wherein automatically turning on, by the harvesting system, the harvester based on the power take off turning on comprises automatically turning on, by the harvesting system, the table, the boom, the elevator, and the plow based on the power take off turning on.

13. The method of claim 11, wherein automatically turning off, by the harvesting system, the harvester based on the power take off turning off comprises automatically turning off, by the harvesting system, the table, the boom, the elevator, and the plow based on the power take off turning off.

14. The method of claim 8, wherein selecting, by the operator, an operating speed of the boom comprises reducing the operating speed of the boom.

15. A method of transitioning a first truck and a second truck during harvesting using a harvesting system, the harvesting system comprising a vehicle and a harvester, the harvester comprising a plow, an elevator, a table, and a boom, the vehicle comprising a power take off, the method comprising:
automatically controlling, by the harvesting system, the boom to empty the boom into the first truck;
automatically controlling, by the harvesting system, the boom to at least partially fill at least one of the table and the boom;
positioning a second truck proximate the boom;
automatically controlling, by the harvesting system, the boom to at least partially fill the second truck.

16. The method of claim 15, wherein automatically controlling, by the harvesting system, the boom to at least partially fill the second truck comprises automatically controlling, by the harvesting system, the boom to empty the boom into the second truck.

17. The method of claim 15, further comprising resetting a boom distance counter that calculates a distance the boom has traveled.

18. The method of claim 17, further comprising calibrating a boom length in the harvester and setting a rotational speed of the boom to a predetermined speed.

19. The method of claim 18, further comprising calculating a distance the boom has traveled based on the calibrated boom length and the predetermined speed.

20. The method of claim 19, further comprising determining if the boom is empty based on the calculated distance the boom has traveled.
